(19) United States
(12) Patent Application Publication
(10) Pub. No.: US 2014/0354658 A1
(43) Pub. Date: Dec. 4, 2014

(54) Shader Function Linking Graph

(71) Applicant: Microsoft Corporation, Redmond, WA (US)

(72) Inventors: Yuri Dotsenko, Kirkland, WA (US); Carey Glenerin Riddell, Bellevue, WA (US); Richard Lee Plotke, Seattle, WA (US); Matthew David Sandy, Bellevue, WA (US); Andrew John Glaister, Redmond, WA (US)

(21) Appl. No.: 13/907,683

(22) Filed: May 31, 2013

(51) Int. Cl. G06T 1/20

(52) U.S. Cl. CPC G06T 1/20
USPC 345/522

(57) ABSTRACT

Methods, systems, and computer-storage media are provided for shader assembly and computation. Shader functions can be determined without specialization to a particular shader model and finalizing or resource bindings. Embodiments of the present invention facilitate final shader assembly and resource binding through linking before the shader is presented to a GPU driver. In this way, embodiments of the present invention alleviate combinatorial shader explosion and provide protection of intellectual property by not requiring distribution or generation of source code.

### BACKGROUND

Graphics Processing Units (GPUs) are used to process a vast amount of data-parallel computations efficiently. As such, specialized GPU programs, called shaders or kernels, must be optimized well to efficiently exploit parallel hardware. A shader may be used for determining graphical image effects including shading, such as determining appropriate levels of light, color, or texture, on an image element, such as a pixel, vertex, or geometry, for example. A shader may also be used for general purpose parallel computing. Often a desired effect of a shader is carried out by a combination of simpler constituent computations. Achieving high performance generally and for cases of combining constituent parts into a desired specialized GPU program, and across a wide range of GPUs is a very difficult problem unsolved by traditional approaches to shader authoring.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments of the present invention relate generally to shader assembly. In this regard, shader functions can be compiled without specialization to a particular shader model or finalization of resource bindings. Embodiments of the present invention facilitate final shader assembly and resource binding through linking before the shader is presented to a GPU driver, without requiring modifications to GPU drivers or hardware.

### BRIEF DESCRIPTION OF THE DRAWINGS

Embodiments of the invention are described in detail below with reference to the attached drawing figures, wherein:

FIG. 1 is a block diagram of an exemplary computing environment suitable for implementing embodiments of the invention;

FIG. 2 is a block diagram of an exemplary computing system architecture suitable for use in implementing embodiments of the present invention;

FIG. 3 is a flow chart showing a method of assembling a shader, in accordance with an embodiment of the present invention;

FIG. 4 is a flow chart showing a method of generating a shader function linking graph, in accordance with an embodiment of the present invention;

FIG. 5 is a flow chart showing a method of performing shader linking, in accordance with an embodiment of the present invention;

FIGS. 6A-6C illustratively depict an example computer program for using shader linking to create a shader, in accordance with an embodiment of the present invention;

FIG. 7A illustratively depicts traditional construction of a shader using a shader language; and

FIG. 7B illustratively depicts construction of the same shader using a function linking graph (FLG) API, in accordance with an embodiment of the present invention.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention relate generally to shader assembly and computation. Shader specialization is a practice in computer graphics and general purpose computing on graphics processing unit (GPGPU) to deliver performance by making shader computation as concrete as possible upfront. Typically, developers construct frameworks for static shader specialization, producing hundreds or thousands of shader variants, to express the desired computations, either compiled off-line, or at some other time before runtime. Constructs that affects performance, such as constants, control flow, or loop unroll factors, are first parameterized, and a large number of shader variants, induced by permutations of parameters, usually compiled statically and packaged with the final product.

There are several problems with this approach including combinatorial shader explosion: the parameter space becomes so large, it quickly becomes unmanageable. This leads to huge shader databases and binary sizes, and requires excessive compilation times during development. Shader space may even become so large that a product is forced into compiling shader variants at runtime.

Another approach is runtime-only compilation, which addresses deficiencies of shader specialization and is employed in scenarios where computation is not known until runtime or shader specialization space becomes too large. But runtime-only compilation has at least two major drawbacks including (1) unpredictable memory usage and large compilation time (even for small shaders), which degrades the user experience, and (2) lack of intellectual property protection, as shader source code can be easily extracted from the application to reverse-engineer the algorithm.

Other approaches attempting to address these problems introduce other limitations. For example, HLSL classes and interfaces in DirectX 11 was an attempt to address the problem of combinatorial shader explosion by allowing programmers to precompile a collection of concrete implementations of an interface abstract method and, during execution, to instruct the runtime which concrete method to pick. This approach has many issues: the expressiveness is limited because all concrete methods must be available all-at-once during compilation; a separately-developed component cannot be “plugged-in;”; advanced hardware is required, which limits acceptance especially in mobile markets; hardware and driver implementations maybe complicated and their performance degraded; interfaces can exhibit resource under-utilization; and whole-program compilation is required, which is slow and non-scalable.

Still another approach, DirectX 9 Fragment Linking attempted to address the problem of combinatorial shader explosion by designing a shader using fragments—logical pieces of computation, such that particular fragments can be selected for execution in the final shader. However, all fragments had to be designed very carefully to work together in a specific shader, and no reuse of fragments from another shader was possible in a general case. This severely limited expressiveness and flexibility of the approach, and it was quickly abandoned.

In this regard, embodiments of the present invention facilitate compiling shader functions without specialization to a particular shader model or finalization of resource bindings. Some embodiments of the present invention facilitate final shader assembly and resource binding through linking before the shader is presented to a GPU driver, without requiring modifications to GPU drivers or hardware. In this way, embodiments of the present invention alleviate combinatorial shader explosion and provide protection of intellectual property by not requiring distribution or generation of source code. Also in this way, embodiments of the present invention allow separate compilation of functions thereby enhancing expressiveness, flexibility, and code reuse as well as improving compilation time; fast creation of new shaders at runtime, without the need for full-fledged compilation; fast augmentation of shaders with pass-through values, such as adding additional interpolated values to a vertex shader; and further runtime specialization of shaders by way of resource slot remapping, changing resource type, and allowing resource aliasing.

Embodiments of the invention also facilitate adding or modifying interpolated outputs of vertex shaders. Embodiments of the invention may benefit: game engines that require high numbers of specialized shaders by providing compaction of shader variant space; users of DirectImage by combining DirectImage effect graphs into larger shaders and reducing intermediate textures; GPGPU developers, such as users of C++ Accelerated Massive Parallelism (AMP), by avoiding using interfaces and unnecessary buffer copies and providing lower compilation times.

Embodiments of the present invention may be implemented using a programming language such as the High-Level Shader Language (HLSL), developed by Microsoft® for the Direct3D API, OpenGL/CL, Cg, or another suitable programming language. For purposes of consistency, examples of embodiments presented herein use HLSL; however, it is contemplated that embodiments of the present invention may be implemented using other programming languages.

In one aspect, computer-storage media having computer-executable instructions embodied thereon for performing a method for facilitating creation of a shader is provided, wherein the method includes receiving a set of functions comprising one or more instructions associated with graphics processing and information specifying one or more graphics resources; receiving resource slot information, the resource slot information specifying a portion of memory associated with one of the graphics resources; and creating a set of libraries based on the received set of functions, each library including information specifying one or more virtual slots, wherein each virtual slot is associated with one of the graphics resources. The method also includes determining one or more modules from at least one library in the set of libraries; creating a set of module instances, each module instance being created based on a module and comprising the information specifying the one or more virtual slots; and for each module instance, based on the information specifying the one or more virtual slots and the resource slot information, binding one or more of the virtual slots to a resource slot. The method also includes receiving node and edge information specifying one or more nodes and graph edges, each node corresponding to a function in the set of functions, an input signature, or an output signature, and each graph-edge corresponding to one or more edge-values passed between nodes; and based on the received node and edge information, generating a function linking graph (FLG) instance comprising nodes and graph edges. The method further includes linking the FLG instance to the set of module instances.

In another aspect, computer-storage media having computer-executable instructions embodied thereon for performing a method creating an instance of an FLG for determining a shader is provided, wherein the method includes receiving parameter information specifying input parameters and output parameters of a shader; and based on the parameter information, creating a set of input signatures and a set of output signatures. The method also includes receiving a set of function calls; each function call corresponding to a function to be included in the shader, each function comprising one or more operations associated with graphics processing; determining a set of graph nodes, wherein each graph node corresponds to a function call, input signature, or output signature; and determining a set of graph edges, wherein each graph edge corresponds to one or more edge-values to be passed between nodes or a sequence of the nodes, the edge-values determined as either (a) input values or output values of the functions corresponded to by the function calls or (b) input parameters or output parameters of the shader. The method further includes determining a set of associations between the graph edges and the graph nodes, wherein an association between a first graph edge and a first graph node is determined where the first graph edge corresponds to a pass value passed to or from the first graph node.

In another aspect, a computer-implemented method for determining a shader is provided. The method includes compiling a set of functions for performing graphics processing, wherein the functions include information specifying one or more graphics resources, and wherein the compiling includes virtualizing the one or more graphics resources. The method also includes determining one or more graphics processing operations for a shader implemented in a graphics pipeline having one or more physical resources. The method further includes, based on the determined one or more graphics processing operations: binding the one or more virtualized resources of the compiled set of functions to the one or more physical resources of the graphics pipeline; and arranging the compiled functions in an order for execution by a graphics processor that when executed by the graphics processor implements the determined one or more graphics processing operations.

Having briefly described an overview of embodiments of the invention, an exemplary operating environment suitable for use in implementing embodiments of the invention is described below.

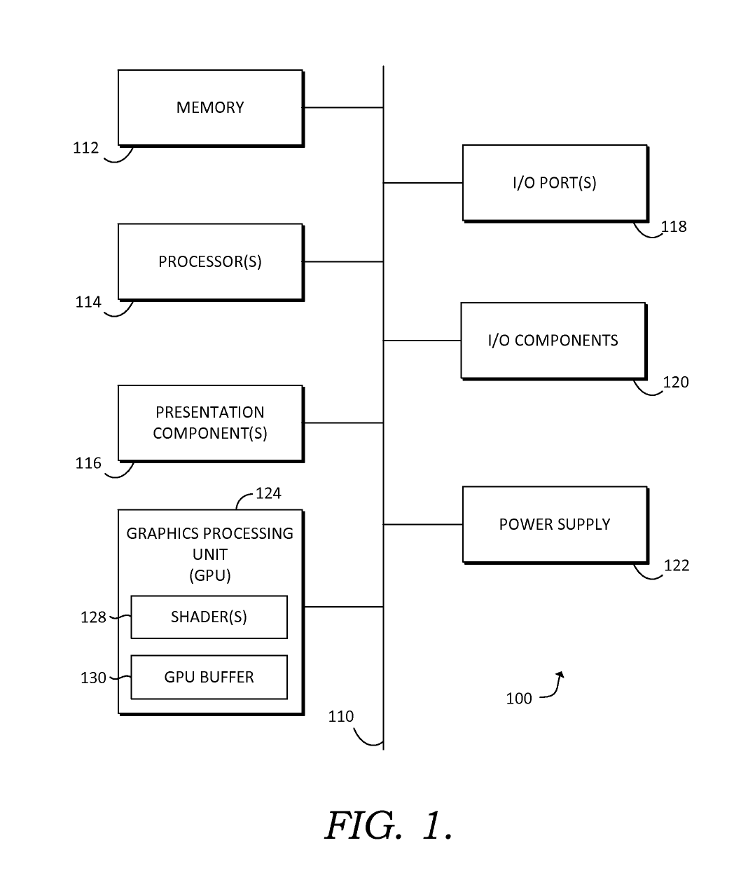

Referring to the drawings in general, and initially to FIG. 1 in particular, an exemplary operating environment for implementing embodiments of the invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implements particular abstract data types. Embodiments of the invention may be practiced in a variety of system configurations, including handheld devices, consumer electronics, general-purpose computers, specialty computing devices, etc. Embodiments of the invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, an illustrative power supply 122, and a graphics processing unit (GPU) 124. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component, such as a display device, to be an I/O component 120. Also, CPUs and GPUs have memory. The diagram of FIG. 1 is merely illustrative of an exemplary computing device that can be used in connection with one or more embodiments of the invention. Distinction is not made between such categories as “workstation,” “server,” “laptop,” “handheld device,” etc., as all are contemplated within the scope of FIG. 1 and reference to “computer” or “computing device.”

Computing device 100 typically includes a variety of computer-storage media. Computer-readable media may be any available media that is accessible by the computing device 100 and includes both volatile and nonvolatile media, removable and nonremovable media. Computer-readable media comprises computer-storage media and communication media.

Computer-storage media includes volatile and nonvolatile, removable and nonremovable media implemented in any method or technology for storage of information such as computer-readable instructions, data structures, program modules or other data. Computer-storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100.

Communication media, on the other hand, embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. As defined herein, computer-storage media does not include communication media. Combinations of any of the above should also be included within the scope of computer-readable media.

Memory 112 includes computer-storage media in the form of volatile and/or nonvolatile memory. The memory 112 may be removable, nonremovable, or a combination thereof. Exemplary memory includes solid-state memory, hard drives, optical-disc drives, etc. Although memory 112 is illustrated as a single component, as can be appreciated, a system memory used by the CPU and a separate video memory used by the GPU can be employed. In other implementations, a memory unit(s) can be used by both the CPU and the GPU.

Computing device 100 includes one or more processors 114 that read data from various entities such as bus 110, memory 112 or I/O components 120. As can be appreciated, the one or more processors 114 may comprise a central processing unit (CPU). Presentation component(s) 116 present data indications to a user or other device. Exemplary presentation components 116 include a display device, speaker, printing component, vibrating component, etc. I/O ports 118 allow computing device 100 to be logically coupled to other devices including I/O components 120, some of which may be built in. Illustrative I/O components 120 include a microphone, joystick, game pad, satellite dish, scanner, printer, wireless device, etc.

Components of the computing device 100 may be used in graphics processing including shader assembly and computation. For example, the computing device 100 may be used to implement shader assembly for determining shaders and a graphics pipeline that processes one or more shaders for applying various effects and adjustments to a raw image element such as a pixel or vertex. Graphic pipelines include a series of operations, which may be specified by shaders that are performed on a digital image. These pipelines are generally designed to allow efficient processing of digital image graphics, while taking advantage of available hardware.

The graphics processing unit (GPU) 124 is a processing unit that facilitates graphics rendering. GPU 124 can be used to process vast amount of data-parallel computations efficiently. The GPU 124 can be used to render images, glyphs, animations and video for display on a display screen of a computing device. A GPU can be located, for example, on plug-in cards, in a chipset on the motherboard, or in the same chip as the CPU. In an embodiment, a GPU (e.g., on a video card) can include hardware memory or access hardware memory. In some implementations, a memory unit(s) that functions as both system memory (e.g., used by the CPU) and video memory (e.g., used by the GPU) can be employed. In other implementations, a memory unit that functions as system memory (e.g., used by the CPU) is separate from a memory unit that functions as video memory (e.g., used by the GPU). As can be appreciated, in some embodiments, the functionality of the GPU may be emulated by the CPU.

To implement a graphics pipeline, one or more shaders 128 on the GPU 124 are utilized. Shaders 128 may be considered as specialized processing subunits or programs of the GPU 124 for performing specialized operations on graphics data. Examples of shaders include a vertex shader, pixel shaders, and geometry shaders. Vertex shaders generally operate on vertices, and can apply computations of positions, colors, and texturing coordinates to individual vertices. For example, a vertex shader may perform either fixed or programmable function computations on streams of vertices specified in the memory of the graphics pipeline. Another example of a shader is a pixel shader. For instance, the outputs of a vertex shader can be passed to a pixel shader, which in turn operates on an individual pixel. Yet another type of shader includes a geometry shader. A geometry shader, which is typically executed after vertex shaders, can be used to generate new graphics primitives, such as points, lines, and triangles, from those primitives that were sent to the beginning of the graphics pipeline.

Operations performed by shaders 128 typically use one or more external graphics-specific resources. These resources can include a constant buffer (cbuffer), texture, unordered-access-view (UAV), or sampler (sampler states), for example. Resources are assigned positions in graphics pipeline memory called “slots” (described below) which are bound prior to execution by the GPU, and are typically bound at compilation time or development time. However, as described below, embodiments of the present invention assign virtual positions to those resources during compilation. Then, at a later time such as a “link-time,” which may occur at runtime, once a structure of the shader is determined, the assigned virtual resource positions are remapped to the appropriate physical or actual positions of the resources.

After a shader 128 concludes its operations, the information may be placed in a GPU buffer 130. The information may be presented on an attached display device or may be sent back to the host for further operations.

The GPU buffer 130 provides a storage location on the GPU 124 where information, such as image, application, or other resources information, may be stored. As various processing operations are performed with respect to resources, the resources may be accessed from the GPU buffer 130, altered, and then re-stored on the buffer 130. The GPU buffer 130 allows the resources being processed to remain on the GPU 124 while it is transformed by a graphics or compute pipeline. As it is time-consuming to transfer resources from the GPU 124 to the memory 112, it may be preferable for resources to remain on the GPU buffer 130 until processing operations are completed.

GPU buffer 130 also provides a location on the GPU 124 where graphics specific resources may be positioned. For example, a resource may be specified as having a certain-sized block of memory with a particular format (such as pixel format) and having specific parameters. In order for a shader to use the resource, it is bound to a “slot” in the graphics pipeline. By way of analogy and not limitation, a slot may be considered like a handle for accessing a particular resource in memory. Thus, memory from the slot can be accessed by specifying a slot number and a location within that resource. A given shader may be able to access only a limited number of slots, such as 16.

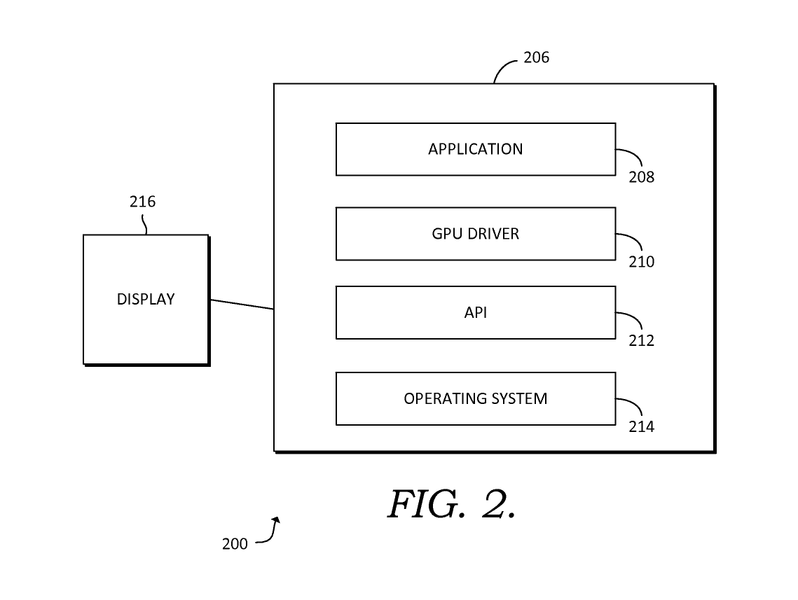

As previously set forth, embodiments of the present invention relate to computing systems shader assembly and computation. With reference to FIG. 2, a block diagram is illustrated that shows an example computing system architecture 200 suitable for use with shader assembly and computation. The computing system architecture 200 shown in FIG. 2 is merely an example of one suitable computing system and does not limit the scope of use or functionality of the present invention. Neither should the computing system architecture 200 be interpreted as having any dependency or requirement related to any single module/component or combination of modules/components.

Computing system architecture 200 includes computing device 206 and display 216. Computing device 206 comprises an application 208, a GPU driver 210, API module 212 and operating system 214. Computing device 206 may be any type of computing device, such as, for example, computing device 100 described above with reference to FIG. 1. By way of example only and not limitation, computing device 206 may be a personal computer, desktop computer, laptop computer, handheld device, mobile handset, consumer electronic device, or the like.

Some embodiments of the exemplary computing architecture shown in FIG. 2 include an application 208. In some embodiments, application 208 transmits data for an image or scene to be rendered. Application 208 may be a computer program for which images or scenes are to be rendered, or may be a computer program for which data parallel operations are to be performed. The images to be rendered or scenarios to be computed may include, but are not limited to, video game images, video clips, movie images, static screen images, protein folding, and other data manipulation. The images may be three-dimensional or two-dimensional, and the data may be completely application specific in nature. Application programming interface (API) module 212 is an interface that may be provided by operating system 214, to support requests made by computer programs, such as application 208. Direct3D®, DirectCompute®, OpenGL®, and OpenCL® are examples of APIs that support requests of application 208. Computing device 206 is in communication with display device 216.

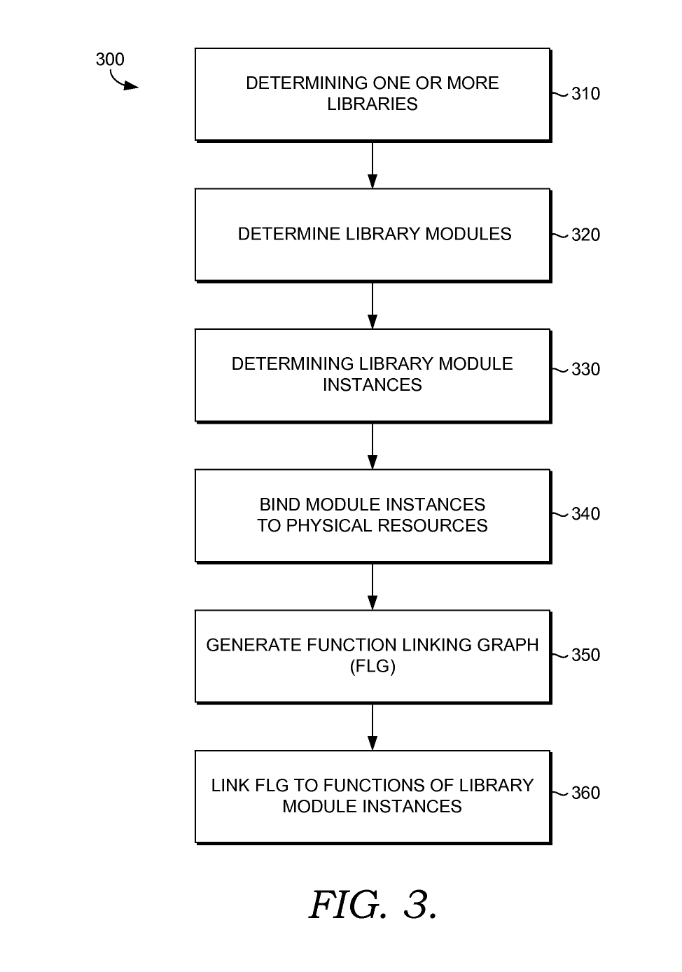

With reference to FIGS. 3-7B, methods and examples of shader assembly and computation, and aspects of such methods and examples are provided herein, in accordance with embodiments of the present invention. As described above, traditionally shaders have been compiled as whole programs at development time; for example, all HLSL functions are inlined first, the program is optimized for a particular shader model, and the resource (samplers, textures, constant buffers, unordered access views) bindings are finalized. But Embodiments of the present invention, by a process referred to herein as shader linking, permit compilation of the functions without specialization to a particular shader model and finalizing resource bindings. Such a function along with metadata information can be stored in a shader library. The function can later be used as a part of the final shader, whose shader model and resource binding are specified at link-time, which may occur at development time, at run-time, or at a time between development time and runtime. Final shader assembly and resource binding may be performed by a shader linker before the shader is presented to a GPU driver.

Turning now to FIG. 3, a method 300 of assembling a shader is described, in accordance with an embodiment of the present invention. Method 300 may be performed by one or more computing systems, such as computing device 206, to assemble a shader that will be presented to a GPU driver, such as GPU driver 210. At step 310, one or more shader libraries are determined A shader library may be determined by compiling an HLSL source file, which is a unit of compilation. Each file may contain several functions and resources shared by these functions. In some embodiments step 310 comprises compiling one or more files to create the one or more libraries. In an embodiment, when a library is compiled, resources accessed by the functions are identified and assigned to one or more virtual slots or locations in memory. Later, the resources assigned to these virtual slots can be accessed by their assigned identities (e.g., virtual slot #3) in order to be rebound to physical (or actual) slots in the GPU pipeline. In some embodiments, libraries may include functions that do not access resources. In these embodiments, the compiled libraries may have no virtual slots. In some embodiments, the compiled libraries are shipped with the executable file(s) and may be used to assemble shaders at a later time, such as at runtime or link-time.

By way of example only and not limitation, a process for creating libraries in accordance with step 310 is provided below. In this example, the export keyword is used to mark functions that become exported to be used for linking later.

```
export float MyAdd(in float x, in float y)
{
  return x + y;
}
export float MyMul(in float x, in float y)
{
  return x * y;
}
```

The extern keyword is used to declare a function prototype and let the compiler know that the function body will be provided via a library function during linking:

extern float MyAdd(in float x, in float y);

extern float MyMul(in float x, in float y);

In this example, which uses HLSL, shader signature parameters also use semantics to indicate special usage of these parameters in the graphics pipeline. When compiling library functions, semantics' special meaning is ignored, as they are not final shaders. Function signatures are not packed either. Each resource (sampler, texture, unordered access view (UAV), constant buffer (cbuffer)) used within a compilation unit can receive a unique virtual slot number. Thus, resources' virtual slot assignments are consistent among functions exported from the same compilation unit.

At step 320, one or more library modules are determined from the library or libraries determined, such as by compilation, in step 310. In an embodiment, the libraries that are needed for a particular graphics process, which does not necessarily include all of the libraries, are loaded into memory. In some embodiments, the developer or an application determines which libraries are needed based on the computations that will be included in the final shader (i.e., which functions will be called).

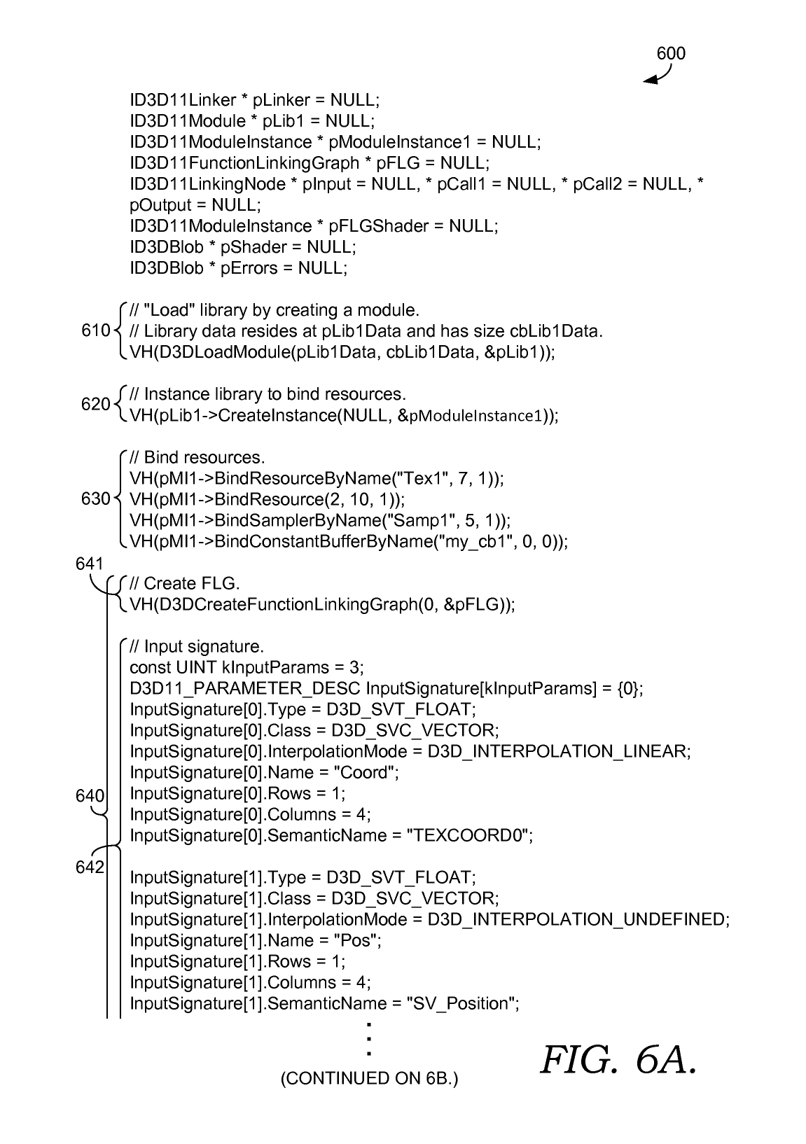

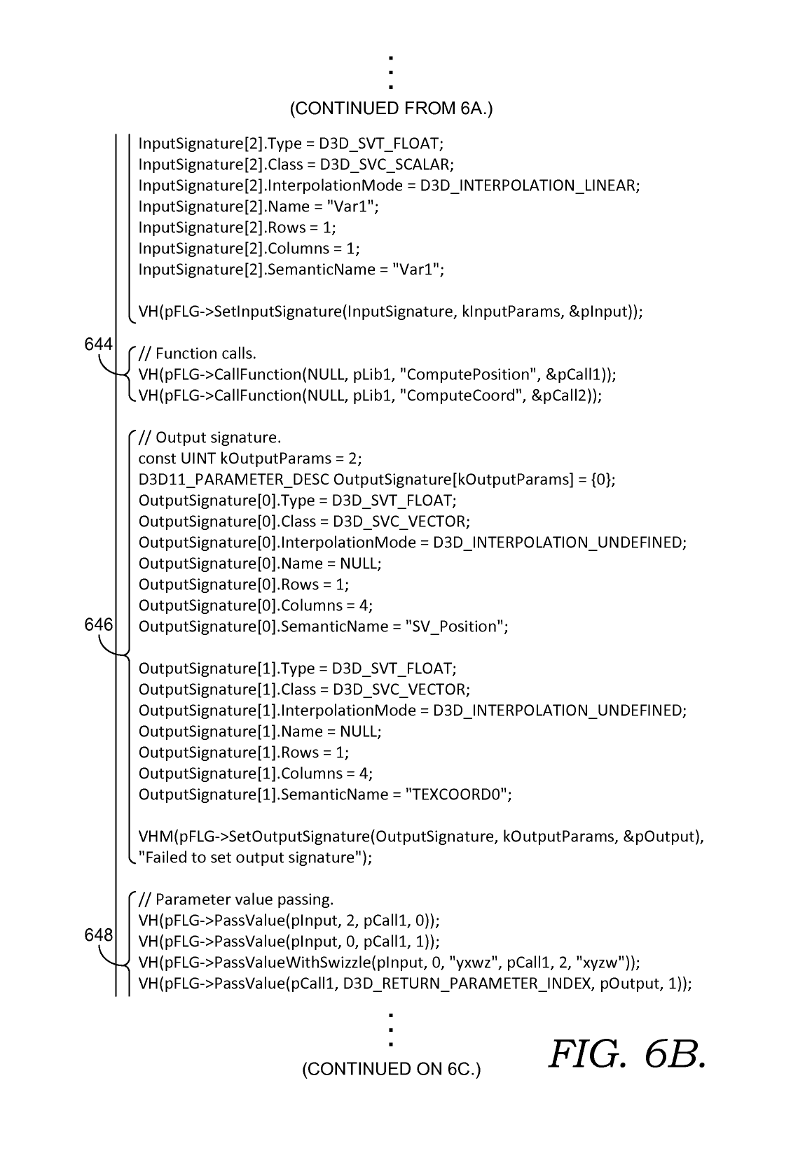

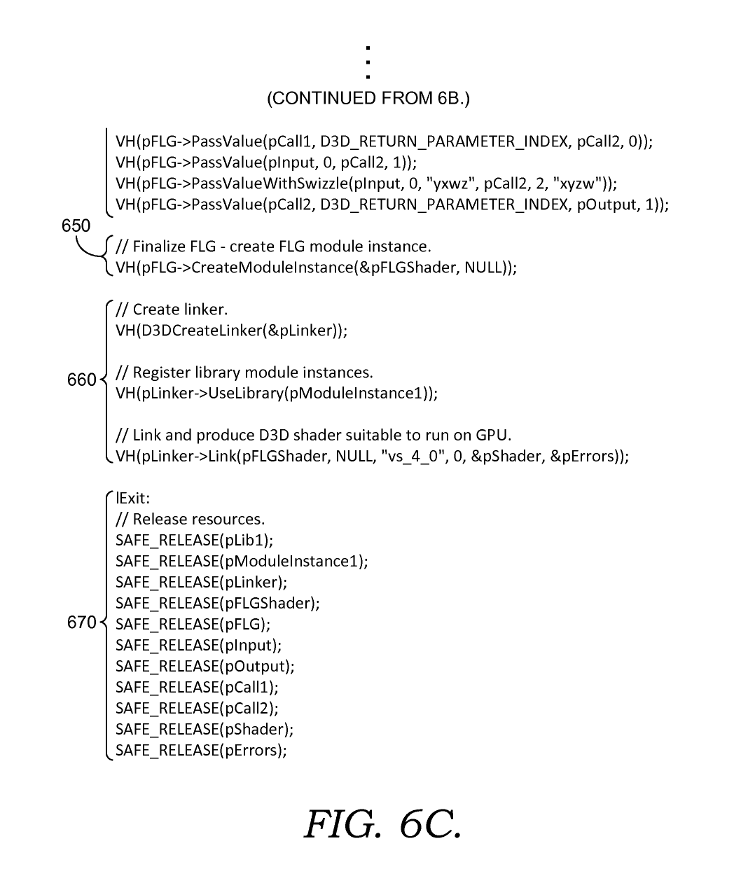

In some embodiments, the library is loaded into memory using an API, which returns a module interface. When the library is transformed into modules, the modules receive the resource information associated with the virtual slots of the library. A module facilitates using the information contained in the library multiple times and more efficiently. In an embodiment of step 320, the library may be deserialized and its contents parsed into one or more data structures in memory, where the data structures may be accessed more readily. In some embodiments, the library is verified for integrity to ensure that it has not been tampered with. In some embodiments, step 320 may occur at a time substantially later than step 310. For example, libraries compiled in step 310 may be shipped with an executable and used in step 320 at link-time, where link-time may occur at runtime. One example process, expressed in HLSL, creating a module from a library, is shown at item 610 of FIG. 6A.

At step 330, one or more library module instances are determined based on the library modules determined in step 320. Constructing a specific shader, or implementing a specific graphics effect may require constructing a pipeline that contains a specific series of operations (e.g., a first and second lighting effect followed by a particular kind of texture lookup, and then another operation, etc.) In an embodiment, library module instances are determined, such as created from a library module, so that the resources associated with the virtual slots may be bound to actual, physical slots. A single library module may be used to create multiple library module instances. The virtual resources now associated with each library module instance may be bound to different actual slots or the same actual slot.

By way of example only, suppose a first library module uses a texture (i.e., the module includes a function that loads a value from a texture), then the library module accesses a texture resource, so the library module includes information about a virtual slot associated with this texture resource. Suppose further that the first module is used to create two module instances, which are both used for assembling a shader. That shader can include functionality for loading two different textures using the same function specified in the module, because there are two module instances and the texture resources for each module instance can be bound to a different actual texture resource block or slot in the pipeline.

By way of a second example, suppose a particular graphics effect calls for two blurs and two texture lookups, and suppose a given second module includes one texture lookup and one blur. All four actions (two texture lookups and two blurs) will be built together into a single shader, in this example. Because the graphics effect calls for two blurs and texture lookups, two module instances can be created based on that given second module. Now for each of these two module instances, the texture lookup can be attached to the appropriate texture and appropriate constants attached to the two blurs, such as described in connection with step 340. One example process, provided without limitation, for creating a module instance is shown at item 620 of FIG. 6A.

An example of a process for creating library module instances from a library, in accordance with steps 320 and 330 is provided below. In this example, a module comprises a unit of precompiled bytecode such as a shader library. The bytecode module can be created at runtime via:

```
HRESULT D3DLoadModule(LPCVOID pSrcData,
    SIZE_T cbSrcDataSize,
  ID3D11Module ** ppModule);
```

In this example, the ID3D11Module encapsulates complexities of dealing with different underlying objects and enables module caching. Creating a bytecode module, for example, can involve heavy processing such as checking the integrity of the data and parsing the bytecode and reflection data to retrieve needed information. ID3D11Module provides a method to create an instance of a module used to rebind resource slots and remap cbuffers.

```
interface ID3D11Module
{
public:
  // Create an instance of a module for resource re-binding.
  HRESULT CreateInstance(LPCSTR pInstanceNamespace,
    ID3D11ModuleInstance ** ppModuleInstance);
};
```

The helper namespace pInstanceNamespace enables the linker to differentiate between functions of two different instances of the same module.

At step 340, module instances are bound to physical resources. Embodiments of step 340 comprise remapping resources from virtual slots or positions to actual pipeline slots, for the module instances. In an embodiment, the resources or virtual slots of the module instances are bound to actual (or physical) resources such as resource slots in the graphics pipeline. The binding of virtual slots to actual slots may be determined by the developer or by an application or the particular desired shader, as described in the examples provided in connection to step 330. Some embodiments of step 340 comprise specifying the source slot (i.e., a virtual slot), the destination slot (i.e., a physical slot in the graphics pipeline), and a count or number of resources to bind. In some embodiments, two or more virtual slots may be associated with the same actual slot, as described in an example provided in connection to step 330. One example process for binding resources of library module instances is shown at item 630 of FIG. 6A.

An example of a process for binding module instance resources is provided below. In this example, the ID3D11ModuleInstance interface enables to customize resource remapping of a module instance. In this example, the remapping information can be used by the linker to assign “physical” resource slots in the final shader:

```
interface ID3D11ModuleInstance
{
public:
  HRESULT BindSampler(UINT uSrcSlot, UINT uDstSlot, UINT uCount);
  HRESULT BindSamplerByName(LPCSTR pName, UINT uDstSlot, UINT uCount);
  HRESULT BindResource(UINT uSrcSlot, UINT uDstSlot, UINT uCount);
  HRESULT BindResourceByName(LPCSTR pName, UINT uDstSlot, UINT uCount);
  HRESULT BindUnorderedAccessView(UINT uSrcSlot, UINT uDstSlot, UINT uCount);
  HRESULT BindUnorderedAccessViewByName(LPCSTR pName, UINT uDstSlot, UINT
uCount);
  HRESULT BindConstantBuffer(UINT uSrcSlot, UINT uDstSlot, UINT uDstOffset);
  HRESULT BindConstantBufferByName(LPCSTR pName, UINT uDstSlot, UINT uDstOffst);
  HRESULT BindResourceAsUnorderedAccessView(UINT uSrcSrvSlot, UINT uDstUavSlot,
UINT uCount);
  HRESULT BindResourceAsUnorderedAccessViewByName(LPCSTR pSrvName, UINT
uDstUavSlot, UINT c);
};
```

In this example, for samplers (s-registers), textures (t-registers), UAVs (u-registers), Bind-functions remap a virtual resource range in the library to a physical resource range in the final shader. For example, BindSampler(1, 4, 2) will map virtual sampler slots [1,2] into physical sampler slots [4,5]. BindResource and BindUnorderedAccessView do the same for textures and UAVs, respectively. BindConstantBuffer remaps the entire virtual constant buffer from slot uSrcSlot into the final constant buffer with uDstSlot at the offset uDstOffset, where offset is specified in cbuffer entries (each entry is 16 bytes). It is possible to map different virtual cbuffers into the same physical cbuffer. BindResourceAsUnorderedAccessView rebinds a Shader Resource View (SRV) range bound at virtual slots [uSrcSrvSlot, uSrcSrvSlot+uCount-1] into the UAV range [uDstUavSlot, uDstUavSlot+uCount-1] in the final shader. Note that in this example, the type of resource is changed from t-register to u-register.

At step 350, a function linking graph (FLG) is generated. As described above, a FLG facilitates hiding or reducing the computational complexity associated with shader assembly by allowing instantiation of only what is needed. The FLG determines the structure of a final executable shader, and may be generated at runtime to create a desired shader. In some embodiments, a shader linker or linking operation is used to create the final shader. In some embodiments, a structure of the FLG is determined by a developer or by the application or the particular desired shader.

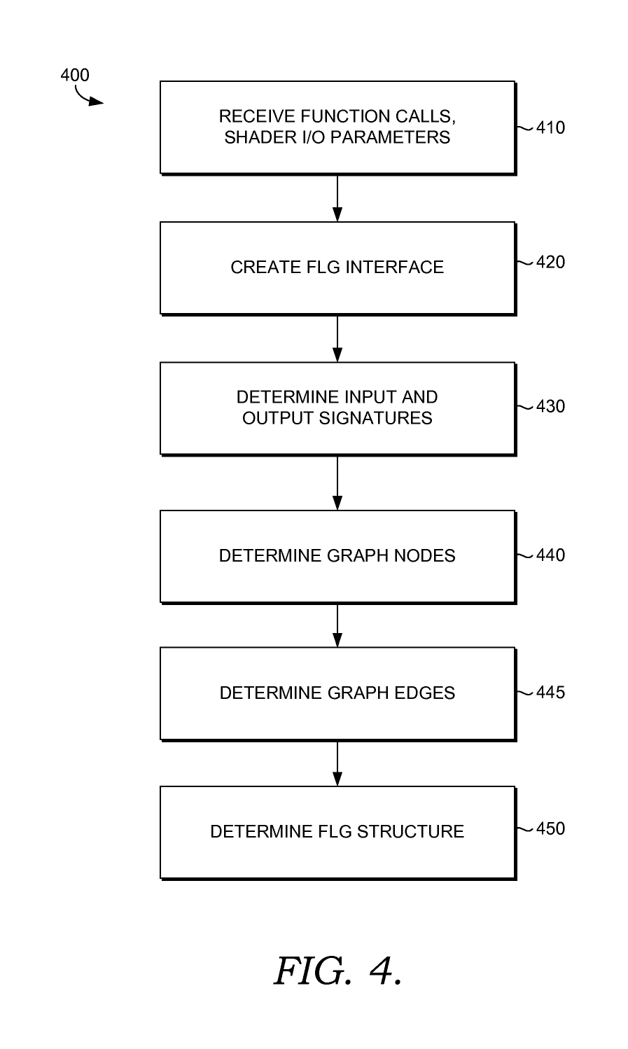

The shader structure can include information about the sequence or order of graphics operations to be performed in the shader, information about values that may be passed from one operation to another, in the sequence, and information about the shader input parameters (specified by the shader input signatures) and output parameters (specified by the shader output signatures). An FLG instance includes this structure information for a particular shader. Conceptually, the FLG may be understood as a graph having nodes and edges for defining the shader structure. In some embodiments, each node corresponds to a particular function (or function call for a function), a shader input signature, or shader output signature; and each graph edge corresponds to one or more values, such as parameter values, passed from node to node, for example, from one operation to another. Additional details describing an embodiment for generating an FLG are provided in connection to FIG. 4.

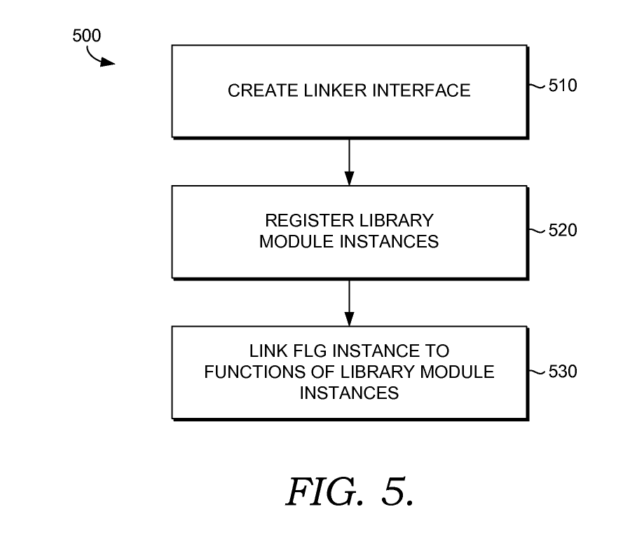

At step 360, an FLG instance is linked to one or more library module instances determined from step 330. As described above, the FLG determines the structure for the final shader. Embodiments of step 360 link the FLG instance to the library module instances, which include function information (from step 310) and bound graphics resources (from step 340), or to functions of the library module instances. In some embodiments, the output of step 360 is the shader. In some embodiments, the linking of step 360 occurs at runtime, and in some embodiments step 360 occurs between development time and runtime, at a time referred to herein as link-time. For example, in some scenarios, such as the construction of very complex shaders, it may be desirable to perform the linking of step 360 prior to runtime. Additional details describing linking of step 360 are provided in connection to FIG. 5.

In some embodiments, method 300 includes an additional step comprising register remapping, and in some embodiments this step is performed as part of linking step 360. A GPU typically does not include a stack, so values computed during processing operations are often stored in available registers. In some embodiments, when a value is produced by a function in a sequence of functions of a shader, the value is placed in a register at some location. But in some instances, it can be determined that it is not necessary to store the value in a register because the value is not consumed by any subsequent functions in the sequence. In other instances it can be determined that a particular value stored in a register, to be used by a function later in the sequence, needs to be preserved in a different register because the original register is overwritten by another function in the sequence. Thus, that value may need to be remapped to another register so that it can be preserved.

By way of example, suppose three functions, function1, function2 and function3, are called one after the other. Suppose function1 produces some values to be used by function3 and the values are placed into register 0. Now suppose function2 performs some computation that overwrites register0. To avoid destroying the values needed by function3, function2 can be remapped to use a different register.

In some embodiments, where values are passed from node to node in the FLG instance, additional or different registers may be required to store the value as well as additional mov instructions to repack the value, such as in cases where a pass with swizzle occurs or a value is assembled from two or more values. In some embodiments, the linker analyzes whether the register of a source value (such as the source of a value-passing edge) can be used to store the destination value (such as the sink of the value-passing edge) such that the following computation is legal. If safe, the linker will reuse the register. In these embodiments, this eliminates a mov instruction and reduces the number of registers used. Similarly in some embodiments, method 300 also performs optimization for shader output values, as they are already assigned register storage (shader output registers). In some embodiments, the register optimization is performed by the linker step 360. Similarly, remapping or optimizing may also comprise restructuring the order of the nodes in the FLG. In some embodiments, during link-time, the linker or a remapping or optimizing routine may, reorder the nodes (or restructure the FLG). In some embodiments, the restructuring or reordering occurs after determining side effects and dependencies.

Turning now to FIG. 4, a method 400 of generating a function linking graph (FLG) is described, in accordance with an embodiment of the present invention. Method 400 may be performed by one or more computing systems, such as computing device 206, and used for assembling a shader to be presented to a GPU driver, such as GPU driver 210.

As described above in connection to step 350, the FLG determines the structure of a final shader, and may be understood as a graph having nodes and edges for defining the shader structure. For example, in some embodiments, each node can correspond to a particular function (or function call for a function), a shader input signature, or shader output signature; and each graph edge can correspond to one or more values passed from node to node. One example process, provided without limitation, for creating an FLG in HLSL is shown at item 640 of FIGS. 6A-6C. In some embodiments, variations of method 400 may be used to create a pass-through only FLG with no function calls. In some of these embodiments, method steps such as 310, 320, 330, and 340 may be unnecessary because, there is no linking to library module instances, but only linking or assembling the FLG structure.

Accordingly, at step 410, function calls and input/output parameters are received. In an embodiment, the function calls correspond to those functions, in the set of functions of step 310 of method 300, for operations to be included in the desired shader; input and output parameters specify shader inputs and outputs.

In some embodiments, at a step 420, an FLG interface or FLG API is created to facilitate creating the FLG. An example of a process creating the FLG interface is provided below, as an example only and without limitation.

HRESULT D3DCreateFunctionLinkingGraph(UINT uFlags, ID3D11FunctionLinkingGraph**ppFunctionLinkingGraph);

At a step 430, input and output signatures are determined. The input and output signatures correspond to the input parameters for the shader and to the output parameters for the shader and are determined based on these parameters. One example process, provided without limitation, for determining input and output signatures is shown at items 642 and 646 of FIGS. 6A-6B, respectively.

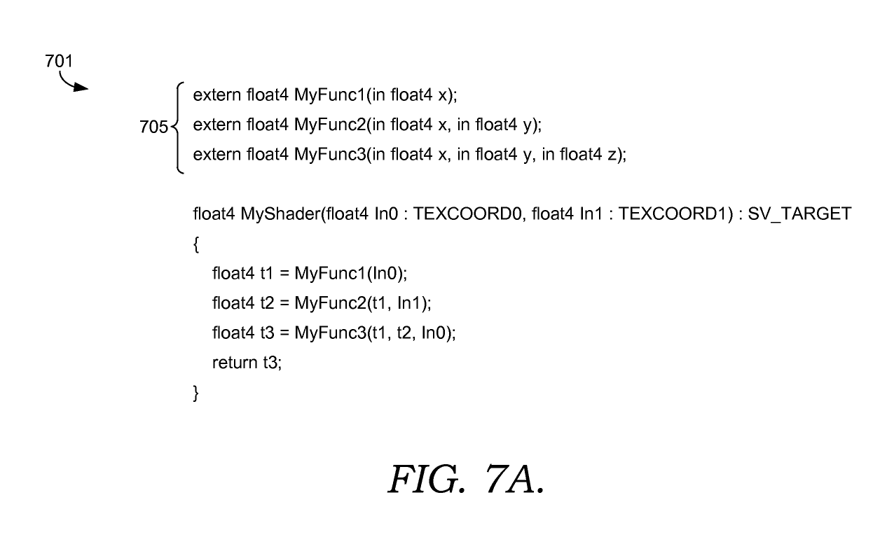

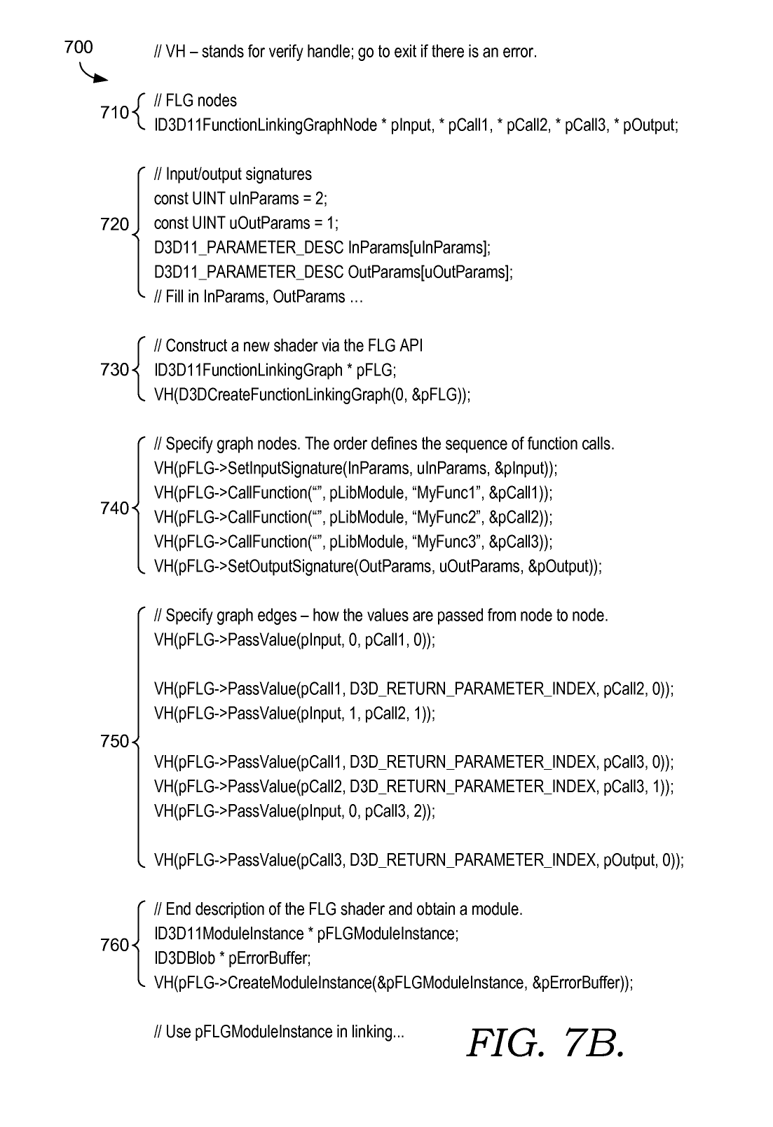

At step 440, the graph nodes of the FLG are determined. As described above in connection to step 350 of method 300, in some embodiments, each node corresponds to a particular function (or function call for a function), a shader input signature, or shader output signature. Accordingly, in some embodiments, graph nodes can be determined from the function calls received in step 410 and the input and output signatures determined in step 430. The sequence or order of functions, which in some embodiments is expressed as the arrangement of nodes and edges, is determined by the desired shader structure, which can be determined as described above. In some embodiments, a chain of function calls is determined specifying the order that functions will be called. In some embodiments, it is possible to have no function calls in the chain, in which case parameters or values are passed directly from an input signature to an output signature. In some embodiments, a function may be called multiple times and correspond to multiple nodes in the FLG. One example process, provided without limitation, for adding function calls to determine graph nodes is shown at item 644 of FIG. 6B. A similar example process, again provided without limitation, is shown as item 740 of FIG. 7B.

At step 445, graph edges of the FLG are determined. As described above in connection to step 350 of method 300, in some embodiments each graph edge corresponds to one or more values passed from node to node. In some embodiments, the graph edges can be determined by the input and output parameters and the values to be passed from node to node (e.g., function to function). In an embodiment, each function can be expecting some input as parameters and may produce some output. In some embodiments, one or more functions may receive zero values as inputs, and in some embodiments, one or more functions may output zero values. For example, in some embodiments, functions may have side effects (perform operations that are not explicitly described by their inputs and outputs), such as writing to a resource, function ordering matters even if the function has no inputs or outputs. In some embodiments, the values passed between nodes are passed with swizzle. One example process, for determining graph edges is shown at item 648 of FIGS. 6B-6C. A similar example process is shown as item 750 of FIG. 7B. In some embodiments, the graph edges comprise order-edges or value-edges. In these embodiments, order-edges include information describing the order of nodes in the FLG (or in a directed acyclic graph) and the value-edges include information describing the passing of values from one node to another. In some embodiments having both graph edge types, the nodes of a resulting FLG structure (described in connection to step 450) would be connected to at least one graph edge comprising an order-edge. In other words, even where the function corresponded to by the node does not receive as input or output a value, a graph edge, specifying order, is still connected to it.

At step 450, the FLG structure is determined. In an embodiment, the FLG structure is determined by forming associations between the graph nodes and edges determined in step 440, such that edges are associated with those nodes for which the values represented by the edge are produced (source) or consumed (sink). In other words, an edge, corresponding to value(s) passed between two nodes is associated with those nodes. In an embodiment, an FLG instance (or FLG module instance) is determined or constructed from the FLG structure. In some embodiments, the FLG is a direct acyclic graph.

An example of a process for generating an FLG API, in accordance with method 400, is provided below. In this trimmed-down example, enumerations for data types, classes, and interpolation modes can be taken from the public DirectX software development kit (SDK). The FLG programmatically defines a call chain and a value-passing DAG (a directed acyclic graph): (a) Shader input and output signatures—start and exit nodes of the call chain, respectively; (b) a chain of library function calls—internal nodes of the chain; and (c) value-passing edges describing how values are passed from various nodes' output parameters to their corresponding nodes' input parameters, possibly with swizzle.

```
// Structure to specify an input/output signature parameter
struct D3D11_PARAMETER_DESC
{
  LPCSTR  Name;  // Parameter name.
  LPCSTR  SemanticName;  // Parameter semantic name+index.
  D3D_SHADER_VARIABLE_TYPE Type;  // Element type.
  D3D_SHADER_VARIABLE_CLASS Class;  // Scalar/Vector/Matrix.
  UINT  Rows;  // Rows are for matrix parameters.
  UINT  Columns;  // Components or Columns in matrix.
  D3D_INTERPOLATION_MODE InterpolationMode; // Interpolation
  mode.
  D3D_PARAMETER_FLAGS  Flags;  // Parameter modifiers.
};
// Reserved slot index for a function return.
#define D3D_RETURN_PARAMETER_INDEX (-1)
// FLG graph node.
interface ID3D11FunctionLinkingGraphNode : public !Unknown { };
// Function Linking Graph.
interface ID3D11FunctionLinkingGraph
{
public:
  // Create a shader module instance out of FLG description.
  HRESULT CreateModuleInstance(ID3D11ModuleInstance **
  ppModuleInstance,
      ID3DBlob ** ppErrorBuffer);
  HRESULT SetInputSignature(
    const D3D11_PARAMETER_DESC* pInParameters,
    UINT cInParameters,
    ID3D11FLGNode ** ppInputNode);
  HRESULT SetOutputSignature(
    const D3D11_PARAMETER_DESC * pOutParameters,
    UINT cOutParameters,
    ID3D11FLGNode ** ppOutputNode);
  HRESULT CallFunction(
    LPCSTR pModuleNamespaceName,
    const ID3D11Module * pModuleWithFunctionPrototype,
    LPCSTR pFuncName,
    ID3D11FLGNode ** ppCallNode);
  HRESULT PassValue(
    ID3D11FLGNode * pSrcNode,
    INT SrcParameterIndex,
    ID3D11FLGNode * pDstNode,
    INT DstParameterIndex);
  HRESULT PassValueWithSwizzle(
    ID3D11FLGNode * pSrcNode,
    INT SrcParameterIndex,
    LPCSTR pSrcSwizzle,
    ID3D11FLGNode * pDstNode,
    INT DstParameterIndex,
    LPCSTR pDstSwizzle);
};
```

In the preceding example, D3D11_PARAMETER_DESC is used to describe a single shader input or output parameter. Here, a programmer may specify: the name of the parameter (can be NULL); semantic name and number as in HLSL. (Names are interpreted according to the HLSL rules.); data element type and min-precision level; shape of the parameter: scalar, vector, matrix; parameter dimensions; and interpolation mode in the pipeline. SetInputSignature and SetOutputSignature define input and output shader parameters, respectively. They return an instance of ID3D11FLGNode that represents a node of the FLG call chain.

CallFunction registers a call site node. Here, the prototype of the function is taken from a module to perform early type checking. The pair pModuleNamespaceName and pFuncName uniquely identify function prototype for the linker to locate the right function bytecode among registered module instances. In some embodiments, CallFunction or a similar calling function may be called once per function to include inside the shader.

PassValue specifies that a value is passed from pSrcNode's parameter SrcParameterIndex to pDstNode's parameter DstParameterIndex. The source and destination parameters have conformant type and shape. The parameter may be enumerated starting with 0. The return value is expressed via a reserved index D3D_RETURN_PARAMETER_INDEX. PassValueWithSwizzle is an extended version of PassValue that also specifies source and destination swizzle of vector components. In an embodiment, swizzles may be specified as in HLSL, e.g., “xxxx”, “xyzw”, “zx”, etc. Pass-through values can be specified as values passed from an input signature parameter to an output signature parameter.

Turning now to FIG. 5, a method 500 of performing shader linking is described, in accordance with an embodiment of the present invention. Method 500 may be performed by one or more computing systems, such as computing device 206, and used for assembling a shader to be presented to a GPU driver, such as GPU driver 210.

As described above in connection to step 360, an FLG instance is linked to one or more library module instances determined from step 330 of method 300. As described above, the FLG determines the structure for the final shader. Embodiments of method 500 link the FLG instance to the library module instances. One example process for performing shader linking, in accordance with method 500 is shown at items 660 of FIG. 6C.

In some linking embodiments, at step 510, a linker object is created. In some embodiments, a linker interface is created to facilitate creating a linker to perform linking. An example of a process creating the linker interface is provided below.

HRESULT D3DCreateLinker(ID3D11Linker**ppLinker);

At step 520, library module instances are registered. In an embodiment, those library module instances to be used in the shader are registered with the linker object. In some embodiments using HLSL, the UseLibrary function is invoked to register library module instances. One example process for registering library instances is shown within item 660 of FIG. 6C.

At step 530, an FLG instance (FLG module instance) is linked to one or more library module instances. In some embodiments, the output of step 530 is a shader or portion of a shader for the GPU driver. By way of analogy only, the FLG module instance is like the main function of a program. Each function node in the FLG structure refers to a corresponding function in a registered library module instance.

An example of a process for determining a linker interface, in accordance with method 500 is provided below.

```
interface ID3D11Linker
{
public:
  // Add an instance of a library module to be used for linking.
  HRESULT UseLibrary(ID3D11ModuleInstance * pLibraryMI);
  // Add a 10L9 clip plane where plane coefficients are taken from a
  cbuffer entry.
  HRESULT AddClipPlaneFromCBuffer(UINT uCBufferSlot, UINT
  uCBufferEntry);
  // Link the shader and produce a shader blob suitable to D3D runtime.
  HRESULT Link(ID3D11ModuleInstance * pModuleInstance,
    LPCSTR pEntryName,
    LPCSTR pShaderTarget,
    UINT uFlags,
    ID3DBlob ** ppShaderBlob,
    ID3DBlob ** ppErrorBuffer);
};
```

In this example, UseLibrary method is first called to register module instances that will supply bytecode for functions and resources for the linked shader. AddClipPlaneFromCBuffer enables to register a 10L9-style clip plane where the plane coefficients are taken from uCBufferEntry of a cbuffer bound at slot uCBufferSlot. After that, the Link method is used to create a shader suitable to run on the existing D3D runtime. In this example, the link method uses: a module instance for the entry point (FLG, shader or library); a name of the entry point; a shader model. This particular example returns a ready-to-run shader blob in ppShaderBlob on success and optional diagnostics in the ppErrorBuffer blob.

Turning now to FIGS. 6A-6C, an example computer program for using shader linking to create a shader is illustratively provided and referred to herein as linker 600, which is shown across FIGS. 6A-6C. With continuing reference to linker 600, at 610, library is loaded into memory to create a library module. At 620, library instances are determined from the library module. At 630, resources of the library instances are bound. At 640, the FLG is created. At 642 and 646 the input signatures and output signatures are determined, respectively. At 644, function calls of the shader are determined. At 648, parameter values passing for the FLG edges are determined. At 650, an FLG module instance is determined from the FLG. At 660, linking is performed and resources are released. The output of example linker 600 is a D3D shader suitable to run on GPU 124.

Turning to FIGS. 7A and 7B, an example of a traditional HLSL shader entry point 701 (shown in FIG. 7A) is provided for comparison with shader construction 700 using an FLG API in accordance with an embodiment of the present invention (shown in FIG. 7B). With reference to FIG. 7A, the example traditional shader, comprises writing and compiling an HLSL “gluing” program that invokes precompiled external functions 705. These external functions 705 are included in an include file or within the code, and need to be available at compile time. Example shader construction 700, on the other hand, uses the FLG API and enables very fast construction of new shaders at runtime, as it avoids full-fledged compilation. With reference to FIG. 7B, at 710, handles for the nodes of the FLG are determined. At 720, input and output signatures are determined. At 730, a shader is constructed via the FLG API. At 740, graph nodes for the FLG are determined. Here, the order defines the sequence of function calls. At 750, graph edges of the FLG are determined At 760, an FLG module instance is determined from the FLG.

The exemplary methods are illustrated as a collection of blocks in a logical flow graph representing a sequence of operations that can be implemented in hardware, software, firmware, or a combination thereof. The order in which the methods are described is not intended to be construed as a limitation, and any number of the described method blocks can be combined in any order to implement the methods, or alternate methods. Additionally, individual operations may be omitted from the methods without departing from the spirit and scope of the subject matter described herein. In the context of software, the blocks represent computer instructions that, when executed by one or more processors, perform the recited operations.

Embodiments of the present invention have been described in relation to particular embodiments, which are intended in all respects to be illustrative rather than restrictive. Alternative embodiments are possible without departing from its scope. It will be understood that certain features and subcombinations are of utility and may be employed without reference to other features and subcombinations. This is contemplated by and is within the scope of the claims.

The invention claimed is:

1. Computer-storage media having computer-executable instructions embodied thereon for performing a method for facilitating creation of a shader, the method comprising:
receiving a set of functions comprising one or more instructions associated with graphics processing and information specifying one or more graphics resources;
receiving resource slot information, the resource slot information specifying a portion of memory associated with one of the graphics resources;
determining a set of libraries based on the received set of functions, each library including information specifying one or more virtual slots, wherein each virtual slot is associated with one of the graphics resources;
determining one or more modules from at least one library in the set of libraries;
determining a set of module instances, each module instance being determined based on a module and comprising the information specifying the one or more virtual slots;
for each module instance, based on the information specifying the one or more virtual slots and the resource slot information, binding one or more of the virtual slots to a resource slot;
receiving node and edge information specifying one or more nodes and graph edges, each node corresponding to a function in the set of functions, an input signature, or an output signature, and each graph-edge corresponding to one or more edge-values passed between nodes;
based on the received node and edge information, generating a function linking graph (FLG) instance comprising nodes and graph edges; and
linking the FLG instance to the set of module instances.

2. The computer-storage media of claim 1, wherein determining one or more modules from at least one library comprises loading the at least one library into memory and deserializing the library by parsing it into one or more data structures in memory.

3. The computer-storage media of claim 1, wherein linking the FLG instance to the set of module instances comprises:
creating a linker interface;
registering with the linker interface each module instance of the set of module instances; and
linking to the FLG instance each registered module instance.

4. The computer-storage media of claim 1, further comprising:
receiving information specifying input parameters and output parameters of a shader;
determining the input signature based on the input parameters; and
determining the output signature based on the output parameters.

5. The computer-storage media of claim 1, further comprising:
determining that an edge-value should be preserved;
determining that the edge-value is to be stored in a first register that will be overwritten by an intermediate function; and
remapping the edge-value or the intermediate function to a second register such that the edge-value is preserved.

6. The computer-storage media of claim 1, wherein the FLG instance is created at runtime.

7. The computer-storage media of claim 1, wherein the shader is created at runtime.

8. The computer-storage media of claim 1, wherein the shader is used for operating upon data in a data-parallel manner.

9. The computer-storage media of claim 1, wherein the shader is used for computing graphics pipeline element values.

10. Computer-storage media having computer-executable instructions embodied thereon for performing a method for creating an instance of a function linking graph for determining a shader, the method comprising:
receiving parameter information specifying input parameters and output parameters of a shader;
based on the parameter information, generating a set of input signatures and a set of output signatures;
receiving a set of function calls; each function call corresponding to a function to be included in the shader, each function comprising one or more operations associated with graphics processing;
determining a set of graph nodes, wherein each graph node corresponds to a function call, input signature, or output signature;
determining a set of graph edges, wherein each graph edge corresponds to one or more edge-values to be passed between nodes or a sequence of the nodes, the edge-values determined as either (a) input-values or output-values associated with the functions corresponded to by the function calls or (b) input parameters or output parameters of the shader; and
determining a set of associations between the graph edges and the graph nodes thereby creating a function linking graph instance, wherein an association between a specific graph edge and a specific graph node is determined where the specific graph edge corresponds to an edge-value passed to or from the specific graph node.

11. The computer-storage media of claim 10, further comprising a subset of the set graph edges, wherein each graph edge of the subset includes information specifying a swizzle operation to be performed on the corresponding one or more edge-values.

12. The computer-storage media of claim 10, wherein each edge-value of the one or more edge-values to be passed between nodes comprises one of an integer, float, unsigned integer, boolean value, or resource, and wherein the edge-value has a dimensionality that comprises one of a scalar, vector, or matrix.

13. The computer-storage media of claim 10, wherein the instance of a function linking graph is used for determining the shader at runtime.

14. The computer-storage media of claim 13, wherein the determined shader is used for computing graphics pipeline element values or for operating upon data in a data-parallel manner.

15. The computer-storage media of claim 10, wherein the received set of function calls includes function-order information; wherein determining a set of graph nodes comprises determining an order for the graph nodes; and wherein a first node corresponds to an input signature, the last node corresponds to an output signature, and the order of intermediate nodes is determined based on the function-order information of the received set of function calls.

16. The computer-storage media of claim 10, further comprising linking the function linking graph instance to a set of library module instances, wherein each library module instance is determined based on a library corresponding to a function to be included in the shader.

17. A computer-implemented method for determining a shader, the method comprising:
(a) compiling a set of functions for performing graphics processing; wherein the functions include information specifying one or more graphics resources, and wherein the compiling includes virtualizing the one or more graphics resources;
(b) determining one or more graphics processing operations for a shader implemented in a graphics pipeline having one or more physical resources; and
(c) based on the determined one or more graphics processing operations:
(1) binding the one or more virtualized resources of the compiled set of functions to the one or more physical resources of the graphics pipeline; and
(2) arranging the compiled functions in an order for execution by a graphics processor that when executed by the graphics processor implements the determined one or more graphics processing operations.

18. The computer-implemented method of claim 17 wherein part (a) occurs at development time and parts (b) and (c) occur at or near runtime.

19. The computer-implemented method of claim 17, wherein arranging the compiled functions in an order comprises:
receiving parameter information specifying input parameters and output parameters of the shader;
based on the parameter information, creating a set of input signatures and a set of output signatures;
receiving an ordered set of function calls; each function call corresponding to a function, of the set of functions, to be included in the shader; wherein each function is operable to receive at least one function-input value and output at least one function-output value;
determining an ordered set of graph nodes, wherein each graph node corresponds to a function call, input signature, or output signature, and wherein the graph nodes are ordered based on the received ordered set of function calls;
determining a set of graph edges, wherein each graph edge corresponds to one or more edge-values to be passed between nodes, the edge-values determined as either (a) input-values or output-values of the functions corresponded to by the function calls or (b) input parameters or output parameters of the shader; and
determining a set of associations between the graph edges and the graph nodes, wherein an association between a first graph edge and a first graph node is determined where the first graph edge corresponds to an pass edge-value passed to or from the first graph node.

20. The computer-implemented method of claim 19, further comprising:
determining that an edge-value should be preserved;
determining that the edge-value is to be stored in a first register that will be overwritten by an intermediate function; and
remapping the edge-value or the intermediate function to a second register such that the edge-value is preserved.
